(19) United States
(12) Patent Application Publication
(10) Pub. No.: US 2018/0096575 A1
(43) Pub. Date: Apr. 5, 2018

(54) SYSTEM FOR FACILITATING SURVEILLANCE VIDEO ANALYSIS

(71) Applicant: Motaz Aladas, Ottawa (CA)

(72) Inventor: Motaz Aladas, Ottawa (CA)

(21) Appl. No.: 15/283,481

(22) Filed: Oct. 3, 2016

(51) Int. Cl. G08B 13/196

(52) U.S. Cl. CPC G08B 13/19673; G08B 13/1966; G08B 13/19645

(57) ABSTRACT

A method for facilitating surveillance video analysis comprising the steps of capturing videos by video cameras each having a unique video camera number, detecting a network interface unique identifier included in a mobile computing device and placing an associated time stamp on the detected network interface unique identifier by receivers installed at the locations. Each of the receivers is paired with one of the unique video camera number. A central server analyzes the unique video camera numbers, the detected network interface unique identifiers and the associated time stamps against a search query for a target network interface unique identifier provided by a user. On finding a match the central server provides a list comprising the unique video camera numbers paired with the receivers which detected the target network interface unique identifiers and the associated time stamps.

### FIELD OF THE INVENTION

The present invention relates to surveillance systems. More particularly, the present invention relates to identification of segments of interest in surveillance videos.

### BACKGROUND OF THE INVENTION

Closed-circuit television (CCTV) cameras are positioned at many public and private places for surveillance or other private purposes. The sophistication of a digital surveillance system can vary depending on the application. For example, in a lower cost application, a single camera is typically mounted at a traffic signal. Video data generated by such a camera is either stored in a local memory storage device or is transmitted as digital data over the Internet to a remote memory storage device. While such a system provides a certain level of security it has some inherent disadvantages or drawbacks. For example, video data requires significant bandwidth for transmission. Thus, it is typically prohibitive to send continuous video data over a Wide Area Network (WAN) such as the Internet to a remote site. Again, it often becomes difficult to identify a suspect from a video feed provided by a CCTV camera based only on visual recognition. Also, viewing of a complete video to locate a particular segment requires enormous amount of time and effort. The present day video surveillance systems used at public or private places do not give any real-time alert when a suspect visits an area under surveillance.

Thus, there is a need for a cost-effective method which can address the aforementioned drawbacks of surveillance systems.

### OBJECTS OF THE INVENTION

An object of the present invention to provide a system and method for enhancing effectiveness of video surveillance.

Yet another object of the present invention is to provide a system and method for facilitating identification of one or more segments of interest from a surveillance video.

Still another object of the present invention is to provide a system and method for identifying, locating and tracking of a suspect with respect to a unique identity of mobile device's WIFI network interface or Bluetooth network interface carried by the suspect.

Another object of the present invention is to provide a system and method for giving alert related to presence of a suspect in a surveillance video.

These as well as other objects of the present invention are apparent upon inspection of this specification, including the drawings and appendices attached hereto.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to a system in which one or more receivers equipped with WIFI and/or Bluetooth network interface detection modules are installed alongside surveillance cameras (video cameras). Every surveillance camera is assigned a unique video camera number and one or more receivers installed at a location along with a video camera are associated with the video camera by this unique video camera number. The association or pairing of a video camera with one or more receivers can be done based on the GPS coordinates of the one or more receivers also. Most of the mobile computing devices such as smartphones, tablets and laptops are provided with wireless communication modules so that the devices can use wireless communication modes such as WiFi, Bluetooth etc. The WiFi or Bluetooth signals can be identified by their MAC (Media Access Control) addresses which are unique to each of the network interfaces. The receiver of the present invention scans the area around it and records the MAC addresses discovered by it. The receiver then places an associated time stamp with each of the discovered MAC addresses. The receiver further detects signal strength, mobile device vendor name and Bluetooth friendly name etc. A database comprising the detected MAC addresses can be accessed by a central server of the present invention. The central server can also access a central video recording server which maintains the videos captured by the video cameras. When one or more receivers detect a particular network interface unique identifier of a mobile computing device, the central server can identify the specific video cameras, thus the videos, based on the association of the unique video camera numbers with the receivers if a query is made for that particular network interface unique identifier. The central server can also identify the specific segments of the videos with respect to detection of the network interface unique identifier based on the associated time stamps. If a query is made with specific video camera numbers and specific time period, the server can provide the list of mobile computing devices with time stamps detected by the specific video cameras for the specific time period.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 illustrates a general environment for implementing the principles of the present invention;

FIG. 2 illustrates a flowchart depicting the general steps associated with a method for finding segments of video with respect to detection of a network interface unique identifier in accordance with an embodiment of the present invention; and

FIG. 3 illustrates a flowchart depicting the general steps associated with a method for finding segments of video with respect to unique video camera numbers and specific time period in accordance with an embodiment of the present invention.

### DETAILED DESCRIPTION OF THE INVENTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

In computer networking, a Media Access Control address (MAC address) is a unique identifier assigned to a network adapter or network interface hardware by the manufacturer for identification. In other words, the MAC address is a hardware address. Each network interface has its own MAC Address. Thus, no two devices or no two network interfaces should ever have the same MAC address. Accordingly, a modern computing device such as a laptop computer, desktop computer, a Smartphone, a tablet with support for Wired Network (LAN Interface) or Ethernet network adapter as well as other types of network connectivity like Wireless Network (WiFi), Bluetooth will obviously have multiple MAC Addresses, one for each network interface. So, it is possible to distinguish one network adapter or network interface controller from another, and through it, the different devices hosting such network interfaces. In the following description and in the claims, the expression “network interface unique identifier” is used to refer to a unique identifier such as a MAC address identifying a network interface for Bluetooth and/or WiFi interface of a mobile computing device.

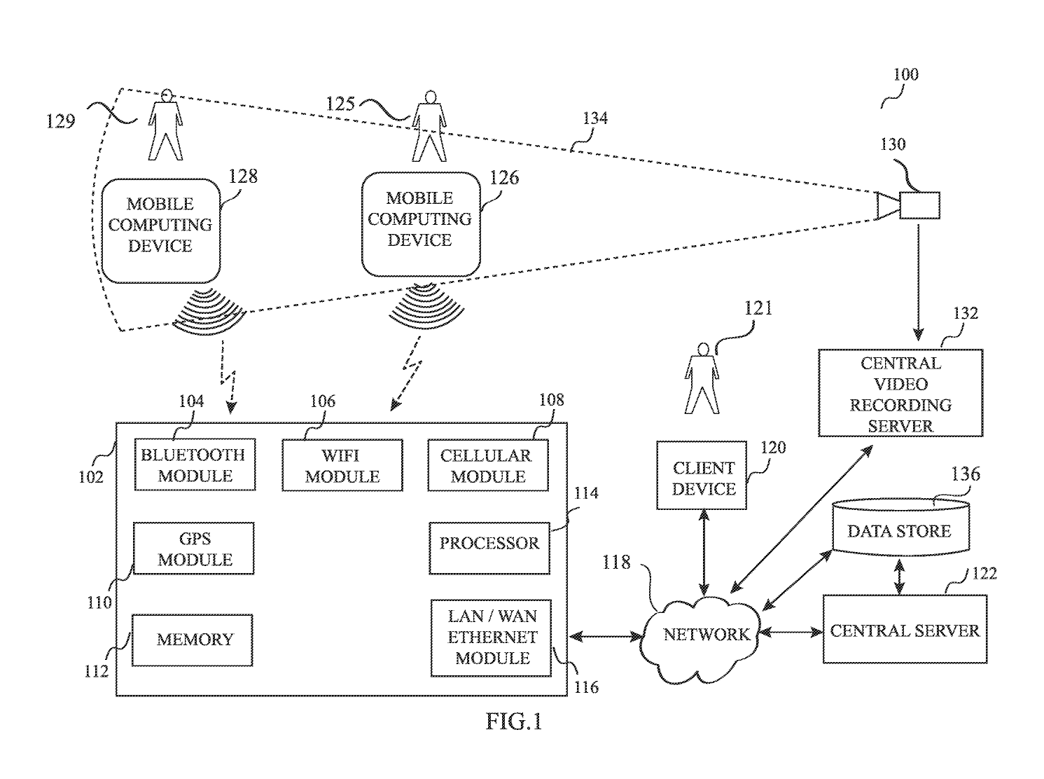

Reference to FIG. 1, the system 100 for enhancing video surveillance comprises one or more video cameras 130, one or more receivers 102, a central server 122, a central video recording server 132 and a data store 136. For simplification purpose FIG. 1 shows only one of each of the above mentioned components of system 100.

The receiver 102 can scan an area around it for detecting presence of any Bluetooth signal or WiFi signal identifiable by network interface unique identifiers with the help of a Bluetooth module 104 and/or a WiFi module 106. The range of the scan can be varied as per requirement. A GPS module 110 included in the receiver 102 obtains time and/or location information with respect to a detected network interface unique identifier and a processor 114 places an associated time stamp on the detected network interface unique identifier. The Bluetooth module 104 and the WiFi module 106 can also detect received signal strength, mobile computing device's vendor name and Bluetooth friendly name etc., all of which are stored on a local memory 112 along with network interface unique identifiers and time stamps. The receiver 102 further comprises a cellular module 108 and a LAN/WAN/Ethernet module 116 through which the receiver can send the detected data in real time over a network 118. The central server 122 stores the received data in data store 136 to form a database comprising detected network interface unique identifiers, associated time stamp, received signal strengths, mobile computing device vendor names and Bluetooth friendly name etc.

As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 118 of FIG. 1 is for descriptive purposes only and it may be wired or wireless. Although, the description may refer to terms commonly used in describing particular public networks such as the Internet, the description and concepts equally apply to other public and private computer networks, including systems having architectures dissimilar to that shown in FIG. 1. The inventive idea of the present invention is applicable for all existing cellular network topologies or respective communication standards, in particular GSM, UMTS/HSPA, LTE and future standards.

The client device 120 may be any computing device including, but not limited to, personal computer, server computer, mobile device, tablets, hand-held or laptop device, smart phone or personal digital assistant. The client device 120 can communicate with the central server through the network 118. Although, only one client device is illustrated in FIG. 1, it is to be understood that there can be a plurality of client devices connected to the central server 122. The central server 122 communicates with the client devices over the network 118 to present a user interface for the enhanced surveillance system of the present invention. The user interface of the surveillance system of the present invention can be presented on the client device through a web browser or through a native mobile application communicating with the central server 122 and is used for displaying, entering and/or managing data.

The surveillance video cameras 130 can be conventional video cameras used for used surveillance purpose or any specific purpose cameras meant for capturing videos. A unique video camera number is assigned to each video camera 130 so that every video camera can be distinguishably identified by the unique number assigned to it. The unique video camera number can be assigned based on the location of the video camera. In FIG. 1, the range of video camera 130 is indicated by an area 134. The range of the video camera 130 may or may not fall within the range of the receiver 102 although, preferably, the receiver 102 should be able to scan the area covered by the video camera 130. In an embodiment, one or more receivers can be installed and paired with a single video camera so that the field of view of the camera is covered entirely by the receivers. In one embodiment, the videos recorded by the one or more video cameras are stored in a central video recording server 132.

The mobile computing device 126 and 128 shown in FIG. 1 can be any computing device such as smartphone, laptop etc. which are provided with wireless network interfaces for wireless communications including Bluetooth and/or WiFi. The mobile computing devices with Bluetooth and/or WiFi modules continuously look for networks to communicate with. For this purpose the devices 126 and 128 regularly broadcast header frames which contain the respective mobile computing device's Media Access Control (MAC) address. Since a MAC address is a network interface identifier address that is unique to that particular device, the MAC addresses (be it of WiFi or Bluetooth) of mobile computing devices 126 and 128 will be different from each other.

In a preferred embodiment, wherever a video camera 130 is placed, one or more receivers 102 are installed at or around the same location. All such associations of one or more receivers 102 with a video camera 130 are individually identifiable by the unique video camera number of the associations/combinations/pairs and the association/pairing data are stored in the database. In some embodiments, the pairing or association of one or more receivers with a video camera is done on the basis of the location of the video camera with respect to the location of the receivers obtained from the GPS coordinates determined by the GPS module 110 of the receivers.

The present invention shall now be explained with reference to an example. Shopping Malls are usually kept under video surveillance by installing a large number of video cameras (CCTV cameras) at different places of the malls. The shopping mall of the present example is also provided with a large number of conventional video cameras at different places. Now, an incident occurs in the mall on Sep. 22, 2016 and the surveillance videos are required to be analyzed to find a suspect. This is a mammoth task considering the fact that videos captured by so many video cameras for the entire day are to be analyzed to see if the suspect appears in one or more videos. The present invention addresses this problem. Reference to FIGS. 1 to 3, the suspect 125 enters the shopping mall at 1230 hours on Sep. 22, 2016 and gets captured by video camera 130. In accordance with an embodiment of the present invention each of the existing video cameras are assigned a unique video camera number and, for example, the video camera 130 is assigned a number “1234”. In the present example the receiver 102 of the present invention makes an association or a pair with this video camera 130 and this pair is identifiable by the video camera number “1234”. Similarly, all the video cameras of the mall are paired/associated individually with one or more independent receivers and the identification number i.e. the unique video camera number of the pairs/associations are stored in the data store 136. The GPS coordinates obtained by the GPS module 110 of the receivers 102 can also be used to associate the one or more receivers 102 with the video camera 130 in terms of their location whenever the receivers are able to obtain the GPS coordinates.

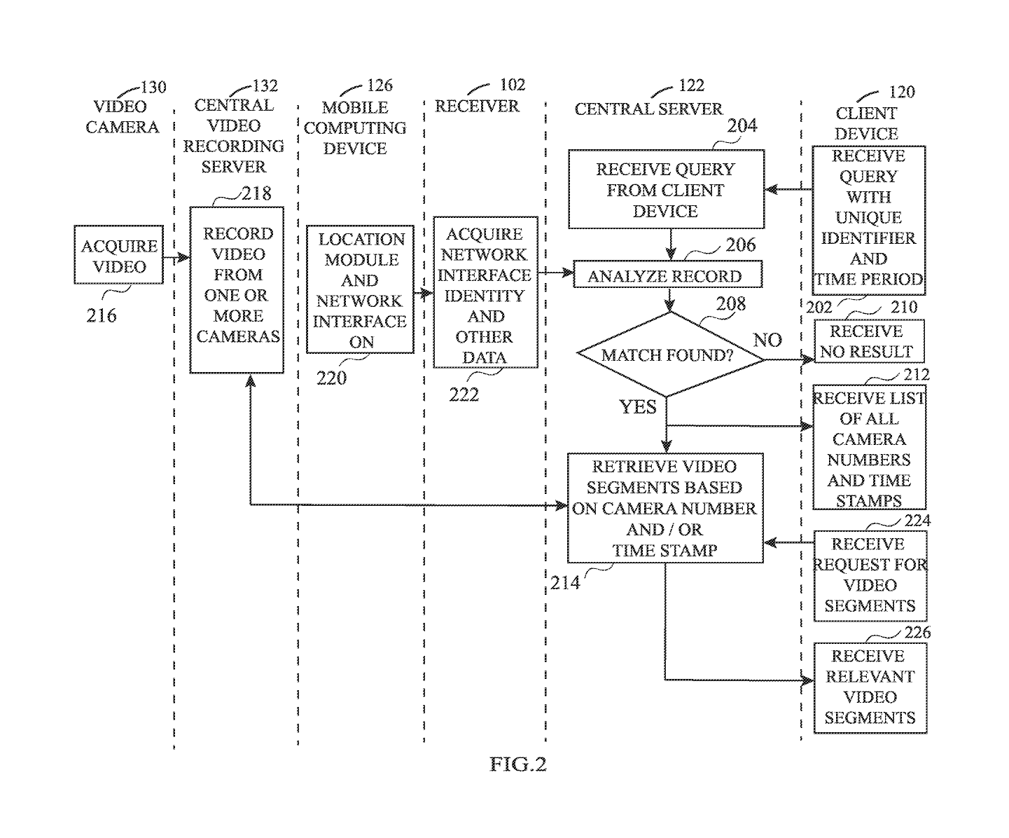

As the receivers of the present invention keep on scanning the areas around them, if the suspect 125 is carrying a smartphone 126, then the receivers of the present invention installed alongside the video cameras will detect any request for communication sent, as in step 220 of FIG. 2, from the smartphone 126 in the form of Bluetooth signal or WiFi signal whenever the smartphone 126 comes within the range of a receiver. The Bluetooth or WiFi signal header emitted by the smartphone 126 contains the Media Access Control (MAC) addresses of the network interfaces and the receiver 102 captures these network interface unique identifiers i.e. the MAC addresses and, with the help of the GPS module 110, places an associated time stamp (1230 hours on Sep. 22, 2016, for example, is the time when receiver 102 detects the smartphone 126) with each of the discovered MAC addresses as in step 222. The receiver also detects the signal strength of the WiFi or Bluetooth signals, mobile device vendor name and Bluetooth friendly name etc. All these data can be stored by the receiver 102 in the memory 112. The data stored in the computer readable memory 112 can be transferred in real time to the data store 136 with the help of the cellular module 108 wirelessly or through wired connection with the help of LAN/WAN/Ethernet module 116. The receiver 102 also supports transfer of data to a removable computer readable device such as a USB flash drive or an SD card.

Continuing with the present example, if we know the target network interface unique identifier (the MAC address of the Bluetooth network interface or of the WiFi network interface) of the smartphone 126, then the present invention will allow to easily find the cameras which may have captured video of the suspect 125 and also the time of detection. To do this, a user (someone from the mall security, for example) 121 can access the user interface of the present invention presented on a client device (a desktop computer, for example) 120 and place a query by submitting the target network interface unique identifier in question and, optionally, the specific time period, through the user interface as in step 202 of FIG. 2. The central server 122 receives this query from the client device 120 as in step 204 and proceeds to analyze the database as in step 206. In the present example, the central server, while analyzing the database, finds that the smartphone 126 of the suspect 125 was detected by the receiver 102 at 1230 hours on Sep. 22, 2016 as in step 208. Since the database also has the information on the unique video camera numbers of the video cameras paired with the receivers, the central server 122 can identify that video camera 130 may probably have captured video of the suspect 125 as, in case of the present example, the video camera 130 is paired with the receiver 102 by means of unique video camera number “1234” which the central server is aware of. Further, since the database includes the associated time stamps placed on the detected network interface unique identifiers, the central server 122 can identify that 1230 hours on Sep. 22, 2016 is the time at which the suspect 125 might have visited the area around video camera 130. This information is provided to the user through the user interface presented on the client device 120 as in step 212. If the central server 122 does not find any match between the target network interface unique identifier and the detected network unique identifiers then the user is informed, as in step 210, about it.

The videos captured through the video cameras, including the videos captured by the video camera 130 as in step 216, are sent to a central video recording server 132 as in step 218. If requested by a user, the central server 122 can identify the exact segments of the videos of interest. In the present example, the user can make a request through the user interface, as in step 224, for the video segments which may contain video of the suspect 125. Since the central server 122 in the present example knows that video camera 130 might have captured video of the suspect 125 at 1230 hours on Sep. 22, 2016, it would access the central video recording server 132 and retrieve the segment of the video captured by the video camera 130 around 1230 hours on Sep. 22, 2016 as in step 214. So, instead of having to watch the entire videos from all the video cameras installed in the shopping mall, the user receives the specific video segment which may have captured video of the suspect 125 as in step 226. In some embodiments, metadata tags (referred hereinafter to as video metadata tags) are inserted to the video files and the corresponding metadata tags (referred hereinafter to as receiver metadata tags) are also linked to the identified MAC addresses. These metadata, for example, may include data representing various conditions such as location, time etc. The identification of the segments of videos of interest can be done on the basis of correlation between the video metadata tags and the corresponding receiver metadata tags placed on the identified MAC addresses.

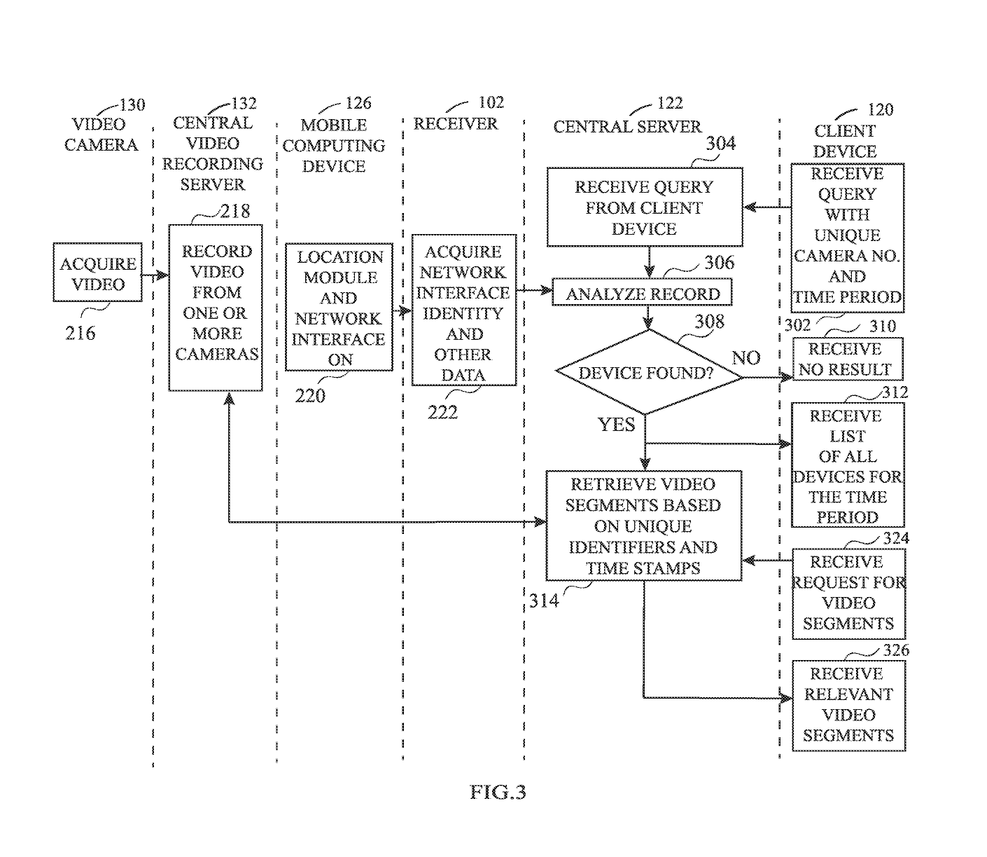

With reference to a second scenario another embodiment of the present invention is described below. The user now wants to know the identity of all the devices which may have came around a specific video camera installed in the shopping mall within a specific time period. For this the user accesses the user interface of the present invention presented on the client device 120 and places a query by submitting the unique video camera number (“1234” in the present example) and the specific time period (between 0900 and 2100 hours on Sep. 22, 2016, for example) through the user interface as in step 302 of FIG. 3. The central server 122 receives this query from the client device 120 as in step 304 and proceeds to analyze the database as in step 306. The central server finds that two smartphone 126 and 128 were detected by the receiver 102 between 0900 hours and 2100 hours on Sep. 22, 2016 as in step 308. Since the database also has the information on the unique video camera numbers of the video cameras paired with the receivers, the central server 122 can identify that, for video camera 130, smartphones 126 and 128 are the only smartphones which may have been detected by the receiver 102 between 0900 hours and 2100 hours on September 22, which is paired with the video camera 130 by means of the unique video camera number “1234”. Thus, the central server 122 can provide a list comprising the detected network interface unique identifiers with respect to a specific unique video camera number for a specific time period as in step 312. If no network interface unique identifier is detected by the receiver 102 corresponding to the video camera 130 during the specific time period, then the user is informed about it as in step 310.

Here also, if requested by the user, the central server 122 can identify the exact segments of the videos of interest. In the present example, the user can make a request through the user interface, as in step 324, for the video segments corresponding to the detected network interface unique identifiers for the specific time period. Based on this request, as in step 314, the central server retrieves the segments of the videos captured by the video camera 130 between 0900 hours and 2100 hours on Sep. 22, 2016 with respect to the time stamps associated with detection of the network interface unique identifiers of smartphones 126 and 128. The segments of the videos can also be retrieved, in some embodiments, with the help of finding correlation between metadata tags inserted in the video files and the metadata tags associated with the time stamps placed on the identified MAC addresses. Accordingly, the central server 122 can provide the user on the client device 120 the specific segments of the videos corresponding to detection of one or more network interface unique identifiers for a specific time period by a receiver paired/associated with a particular video camera as in step 326 of FIG. 3.

The present invention also enables differentiation between known and unknown computing devices based on network interface unique identifiers. For example, if in the database the network interface unique identifier of the smartphone 128 belonging to the manager of the shopping mall 129 is marked as a known identity then, whenever the network interface unique identifier of the mobile computing device 128 is detected by a receiver of the present invention, it is identified as a friendly device. On the other hand, the receivers and/or the central server can be configured to give alert in real time whenever a suspect carrying a mobile computing device having already known network interface unique identifier gets detected by a receiver.

Flowcharts are used to describe the steps of the present invention. While the various steps in these flowcharts are presented and described sequentially, some or all of the steps may be executed in different orders, may be combined or omitted, and some or all of the steps may be executed in parallel. Further, in one or more of the embodiments of the invention, one or more of the steps described above may be omitted, repeated, and/or performed in a different order. In addition, additional steps, omitted in the flowcharts may be included in performing this method. Accordingly, the specific arrangement of steps shown in FIGS. 2 and 3 should not be construed as limiting the scope of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for facilitating surveillance video analysis, said system comprising:
one or more video cameras installed at one or more locations for capturing one or more videos;
one or more receivers installed at said one or more locations, each of said one or more receivers being associated with one of said one or more video cameras and configured to detect a network interface unique identifier included in a mobile computing device and place an associated time stamp or a receiver metadata tag on said detected network interface unique identifier;
a database comprising one or more of said detected network interface unique identifiers and one or more of said associated time stamps or one or more of said receiver metadata tags; and
a central server configured to receive a search query comprising a target network interface unique identifier;
wherein, said central server analyzes said database to find if said target network interface unique identifier matches any of said one or more detected network interface unique identifiers and, on finding a match, provides a list comprising one or more of said one or more video cameras associated with said one or more receivers detecting said target network interface unique identifier and said one or more associated time stamps or said one or more receiver metadata tags.

2. The system as in claim 1, wherein said network interface unique identifier included in said mobile computing device is a MAC address of a WiFi module or a MAC address of a Bluetooth module included in said mobile computing device.

3. The system as in claim 1, wherein said each of said one or more receivers being associated with one of said one or more video cameras based on an location information provided by said each of said one or more receivers.

4. The system as in claim 1, wherein said search query further comprises a specific time period.

5. The system as in claim 4, wherein, said central server analyzes said database to find if said target network interface unique identifier matches any of said one or more detected network interface unique identifiers within said time period and, on finding a match, provides a list comprising one or more of said one or more video cameras associated with said one or more receivers detecting said target network interface unique identifier and said one or more associated time stamps or said one or more receiver metadata tags for said specific time period.

6. The system as in claim 1, wherein a central video recording server stores said one or more videos and one or more video metadata tags inserted into said one or more videos.

7. The system as in claim 6, wherein one or more segments of videos from said central video recording server are identified based on said one or more of said one or more video cameras associated with said one or more receivers detecting said target network interface unique identifier and said one or more associated time stamps.

8. The system as in claim 6, wherein one or more segments of videos from said central video recording server are identified based on said one or more of said one or more video cameras associated with said one or more receivers detecting said target network interface unique identifier and a match between said one or more receiver metadata tags and said one or more video metadata tags.

9. The system as in claim 1, wherein said central server receives said search query through a user interface presented on a client device.

10. The system as in claim 1, wherein a range of said one or more video cameras fall within a range of said one or more receivers.

11. A method for facilitating surveillance video analysis, said method comprising the steps of:
capturing one or more videos by one or more video cameras installed at one or more locations, each of said one or more video cameras being identifiable by a unique video camera number;
detecting a network interface unique identifier included in a mobile computing device and placing an associated time stamp on said detected network interface unique identifier by one or more receivers installed at said one or more locations, each of said one or more receivers being associated with one of said unique video camera number;
storing one or more of said unique video camera numbers, one or more of said detected network interface unique identifiers and one or more of said associated time stamps in a database;
receiving by a central server a search query comprising a target network interface unique identifier; and
analyzing by said central server said database to find if said target network interface unique identifier matches any of said one or more detected network interface unique identifiers and, on finding a match, providing a list comprising one or more of said unique video camera numbers associated with said one or more receivers detecting said target network interface unique identifier and said one or more associated time stamps.

12. The method as in claim 11, wherein said search query further comprises a specific time period.

13. The method as in claim 12, wherein, said central server analyzes said database to find if said target network interface unique identifier matches any of said one or more detected network interface unique identifiers within said time period and, on finding a match, provides a list comprising one or more of said unique video camera numbers associated with said one or more receivers detecting said target network interface unique identifier and said one or more associated time stamps for said specific time period.

14. The method as in claim 11, wherein a central video recording server stores said one or more videos.

15. The method as in claim 14, wherein one or more segments of videos from said central video recording server are identified based on said one or more of said unique video camera numbers associated with said one or more receivers detecting said target network interface unique identifier and said one or more associated time stamps.

16. The method as in claim 11, wherein said central server receives said search query through a user interface presented on a client device.

17. The method as in claim 11, wherein an alert signal is given by said central server on said matching of said target network interface unique identifier with any of said one or more detected network interface unique identifiers in real time.

18. The method as in claim 11, wherein said one or more receivers further detect a signal strength with respect to said one or more of said detected network interface unique identifiers.

19. The method as in claim 11, wherein said mobile computing device is determined as a known device by said central server if said one or more of said detected network interface unique identifiers corresponding to said mobile computing device are already stored in said database.

20. A method for facilitating surveillance video analysis, said method comprising the steps of:
capturing one or more videos by one or more video cameras installed at one or more locations, each of said one or more video cameras being identifiable by a unique video camera number;
detecting a plurality of network interface unique identifiers included in a plurality of mobile computing devices and placing an associated time stamp on each of a plurality of said detected network interface unique identifiers by one or more receivers installed at said one or more locations, each of said one or more receivers being associated with one of said unique video camera number; and
analyzing by a central server said database to provide a list comprising one or more of said plurality of detected network interface unique identifiers discovered for a specific time period by one of said one or more receivers which are associated with a specific unique video camera number.

21. The method as in claim 20, wherein a central video recording server stores said one or more videos.

22. The method as in claim 20, wherein one or more segments of videos from said central video recording server are identified based on said one or more of said plurality of detected network interface unique identifiers and said one or more associated time stamps.
